(19) United States
(12) Patent Application Publication
(10) Pub. No.: US 2025/0119483 A1
(43) Pub. Date: Apr. 10, 2025

(54) SERVER QUEUE MANAGEMENT

(71) Applicant: INTERNATIONAL BUSINESS MACHINES CORPORATION, ARMONK, NY (US)

(72) Inventors: Anthony Philip Papageorgiou, Winchester (GB); Andrew Armstrong, Edinburgh (GB)

(21) Appl. No.: 18/502,278

(22) Filed: Nov. 6, 2023

(30) Foreign Application Priority Data
Oct. 6, 2023 (GB) 2315387.7

(51) Int. Cl. H04L 67/62; G06F 9/48; G06F 9/54

(52) U.S. Cl. CPC H04L 67/62; G06F 9/4887; G06F 9/54; G06F 2209/541; G06F 2209/548

(57) ABSTRACT

Proposed embodiments may thus provide one or more concepts for automatically managing the requests in a server queue, based on information describing the client wait time limit and an indicator of the intent of the request. In particular, embodiments provide a mechanism for managing requests in a server queue.

### BACKGROUND

The technical character of the present invention generally relates to the field of computing servers and more particularly, to managing requests in a queue of a server.

Servers may queue incoming requests during busy periods. Commonly, servers may have a limit on the number of requests that can be processed in parallel. This limit may be a result of the configuration of the server or may be due to a physical limit of the machine. Regardless of how this limit is set, it is common that in busy periods a server may receive more requests than it can process concurrently.

Server queues present a strategy for coping with these busy periods; requests are held in the queue until the server has sufficient resources available to process them. During normal operation, requests spend very little time in the queue and are processed almost immediately. However, during busy periods, the request queue may build up with waiting requests.

This queuing strategy may present problems during sustained busy periods. Clients sending requests to the server will only wait for so long for their request to be processed and will timeout locally if they don't receive a response from the server in a timely manner. The server queue may become so large that clients may timeout before their requests reach the front of the queue. If this occurs, and the rate of incoming requests is equal to or greater than the server's maximum concurrent request capacity, the server will spend most of its time processing requests for clients that are no longer waiting for a response. The server, although processing requests effectively and performing at peak throughput, becomes seemingly unresponsive to new client requests.

### SUMMARY

According to an aspect of the present invention there is provided a computer-implemented method for managing requests in a server queue for a system. The method comprises, analysing a request to be added to the server queue to determine a client wait time limit. The method also comprises determining an application for processing the request and analysing the application to determine an indicator of the intent of the request. The method then further comprises determining a queue action for the request based on the client wait time limit and the indicator of the intent of the request.

According to an aspect of the present invention there is provided a computer-implemented method for managing requests in a server queue for a system. The method comprises, analysing a request to be added to the server queue to determine a client wait time limit. The method also comprises determining an application for processing the request and analysing the application to determine an indicator of the intent of the request. The method then further comprises determining a queue action for the request based on the client wait time limit and the indicator of the intent of the request.

According to another aspect, there is provided a system comprising: one or more processors; a memory comprising code stored thereon that, when executed, performs a method for managing requests in a server queue for a system, the method comprising: analysing a request to be added to the server queue to determine a client wait time limit; determining an application for processing the request; analysing the application to determine an indicator of the intent of the request; and determining a queue action for the request based on the client wait time limit and the indicator of intent of the request.

### BRIEF DESCRIPTION OF THE DRAWINGS

Embodiments of the invention will now be described, by way of example only, with reference to the accompanying drawings in which:

FIG. 1 depicts a computing node according to an embodiment of the present invention;

FIG. 2 depicts an illustrative computing environment according to embodiments of the present invention;

FIG. 3 is a simplified flow diagram of a method according to an embodiment; and

FIG. 4 is a simplified flow diagram of the interaction of a server and a web application according to an embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server or a collection of PCs and/or servers connected via a network such as a local area network, the Internet and so on to cooperatively execute at least one embodiment of the methods of the present invention.

The technical character of the present invention generally relates to the field of server request queues, and more particularly, to managing requests in a queue in a server. More specifically, embodiments of the present invention provide concepts for determining a queue action for a request in a server queue based on a client wait time limit and an indicator of the intent of the request.

The present invention seeks to provide one or more concepts for managing requests in a server queue for a system in order to more efficiently allocate server resources during busy periods. Such concepts may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor. The present invention yet further seeks to provide a system for managing requests in a server queue.

According to an aspect of the present invention there is provided a computer-implemented method for managing requests in a server queue for a system. The method comprises, analysing a request to be added to the server queue to determine a client wait time limit. The method also comprises determining an application for processing the request and analysing the application to determine an indicator of the intent of the request. The method then further comprises determining a queue action for the request based on the client wait time limit and the indicator of the intent of the request.

Proposed embodiments may thus provide one or more concepts for automatically managing the requests in a server queue, based on information describing the client wait time limit and the intent of the request. In particular, embodiments may provide a mechanism for managing requests in a server queue that ensures that client requests can be processed efficiently in busy periods.

Processing all the requests in a server queue in the order they are received, can result in wasted server resources in the case where clients have stopped waiting for a response to their request by the time it reaches the front of the queue. However, it is not possible to discard all requests which no longer have an associated waiting client since: (i) not all requests are safe to discard; and (ii) the server may have imperfect knowledge of the client waiting state. The present invention proposes analysing the application that will process the request to determine an indicator of the intent of the request, and hence whether it is safe to discard or whether it must be processed. In most cases, the outcome that would result from processing a request is not known in the server layer and therefore it is not known in the server whether it is safe to modify the normal processing procedure of the request. The proposed invention provides a mechanism for obtaining this information by analysing the application associated with the request. Further, the present invention proposes determining a request specific client wait time limit, to allow for accurate knowledge of how long a client will wait for a request to be processed. In certain embodiments, this is achieved by analysing timeout metadata associated with the request.

Therefore, the proposed embodiments allow for the determination of suitable queue action for a request in a server queue. In certain embodiments the queue action may be at least one of removing the request from the queue; changing the position of the request in the queue; and maintaining the position of the request in the queue. Thus, the proposed invention provides a solution to the problem of wasted server resources during busy periods, by enabling the server to discard or to deprioritise requests for which there is no client waiting for a response. This leads to an increase in the likelihood that new requests added to the queue will be processed before client timeout occurs.

In addition, embodiments of the present invention provide concepts for a non-transitory computer readable medium comprising code stored thereon that, when executed, performs a method for managing requests in a server queue for a system, the method comprising: analysing a request to be added to the server queue to determine a client wait time limit; determining an application for processing the request; analysing the application to determine an indicator of the intent of the request; and determining a queue action for the request based on the client wait time limit and the indicator of the intent of the request.

Embodiments may be employed in combination with conventional/existing server environments, such as a web server for example. In this way, embodiments may integrate into legacy systems to improve and/or extend their functionality and capabilities. An improved sever environment may therefore be provided by proposed embodiments.

According to another aspect, there is provided a system comprising: one or more processors; a memory comprising code stored thereon that, when executed, performs a method for managing requests in a server queue for a system, the method comprising: analysing a request to be added to the server queue to determine a client wait time limit; determining an application for processing the request; analysing the application to determine an indicator of the intent of the request; and determining a queue action for the request based on the client wait time limit and the indicator of intent of the request.

Thus, there may be proposed concepts for automatically managing requests in a server queue, wherein the concepts provide one or more approaches of using information describing the client wait time limit from the request and information describing the intent of the request, to determine a queue action for the request. These approaches may leverage information from the application that will process the request, and therefore provide superior (e.g., more accurate) queue actions for achieving desired outcomes.

There is provided a method for managing requests in a server queue for a system. The method comprises, analysing a request to be added to the server queue to determine a client wait time limit. The method also comprises, determining an application for processing the request and analysing the application to determine an indicator of the intent of the request. The method then further comprises determining a queue action for the request based on the client wait time limit and the indicator of the intent of the request.

Accordingly, proposed is a concept for determining a queue action for a request in a server queue (such as a web server queue). However, although described in relation to a web server queue, embodiments may be applied to other server environments.

In most server protocols, all requests received by the server are processed, regardless of whether the client is still waiting for a response to the request. However, with the queue management method proposed herein, requests may be discarded from the queue and not processed. This is enabled by analysing the application that will process the request to determine an indication of the intent of the request. Here the intent of the request will be taken by the skilled person to be an indicator of the influence the request may have on the system and the validity of modifying the normal processing procedure for the request. This definition anticipates that this indicator of the intent of the request may contain information describing whether the request is safe to discard or not, the resources required to process the request, or the resulting impact of processing the request on the system state. Information on the intent of a given request is not stored in the server but can be obtained from the application as proposed by the present invention. The information on the intent of the request is then used in conjunction with information describing when the client will timeout, to determine a suitable queue action for the request.

By way of example, the queue action may be at least one of: removing the request from the queue; changing the position of the request in the queue; maintaining the position of the request in the queue; processing the request once it has left the queue; and discarding the request once it has left the queue. Therefore, the present invention proposes a method by which requests that are safe to discard and for which the client is no longer waiting for a response, may be discarded from the queue and not processed, resulting in more efficient use of server resources. Requests which are not safe to discard may still be processed from the queue. It can also be understood from method disclosed herein, that based on the impact of the request and information on the client waiting state, some requests may be prioritised over others, enabling more efficient allocation of available server resources.

Certain embodiments of the present invention propose determining the client wait time limit of a request, describing the absolute time a client will stop waiting for a response to the request, from metadata associated with the request. This metadata may be present in the header of the request, and provides a mechanism for request specific calculation of the client wait time limit that does not depend on knowledge of the client connection state.

By way of summary, embodiments disclosed herein propose to determine a client wait time limit associated with a request in a server queue; and further to determine an indication of the intent of the request by analysing the application in which the request is to be processed, wherein the indicator of the intent of the request may contain information on the effect the request may have on the system. A queue action is then determined based on the client wait time limit and the indicator of the intent of the request. By way of example, the queue action may be at least one of: removing the request from the queue; changing the position of the request in the queue; maintaining the position of the request in the queue; processing the request once it has left the queue, and discarding the request once it has left the queue. Therefore, the result of the proposed method may be to remove requests from the queue that are safe to remove and for which the client has stopped waiting for a response, thus ensuring that a server queue is processed efficiently during busy periods.

By way of example, the following steps outline a process according to the proposed concept(s):
Step 1: analyse a request to be added to the server queue to determine a client wait time limit (e.g., by analysing metadata associated with the request).
Step 2: analyse the application for processing the request (e.g., by accessing the application configurations or making a callback to the application), to determine an indication of the intent of the request.
Step 3: use the determined client wait time limit and the indication of the intent of the request to determine a suitable queue action for the request (e.g., removing the request from the queue, changing the position of the request in the queue, or maintaining the position of the request in the queue).

In embodiments, determining the queue action for the request includes determining the queue action is to maintain the position of the request in the queue if the client wait time limit equals a first predetermined value. In embodiments, determining the queue action for the request includes determining the queue action is to maintain the position of the request in the queue if the impact of the request equals a second predetermined value. In embodiments, determining the queue action for the request comprises determining the queue action is to remove the request from the queue if the client wait time has a third predetermined value and the impact of the request has a fourth predetermined value.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

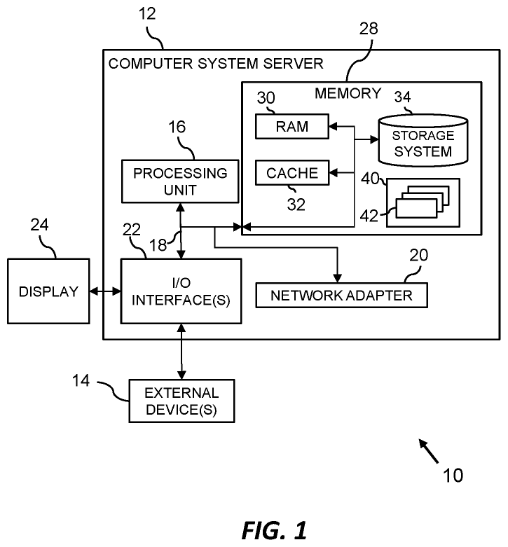

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment.

Program modules 42 generally carry out the functions and/or methodologies of embodiments of the invention as described herein. For example, some or all of the functions of a DHCP client 80 can be implemented as one or more of the program modules 42. Additionally, the DHCP client 80 may be implemented as separate dedicated processors or a single or several processors to provide the functionality described herein. In embodiments, the DHCP client 80 performs one or more of the processes described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID (redundant array of inexpensive disks or redundant array of independent disks) systems, tape drives, and data archival storage systems, etc.

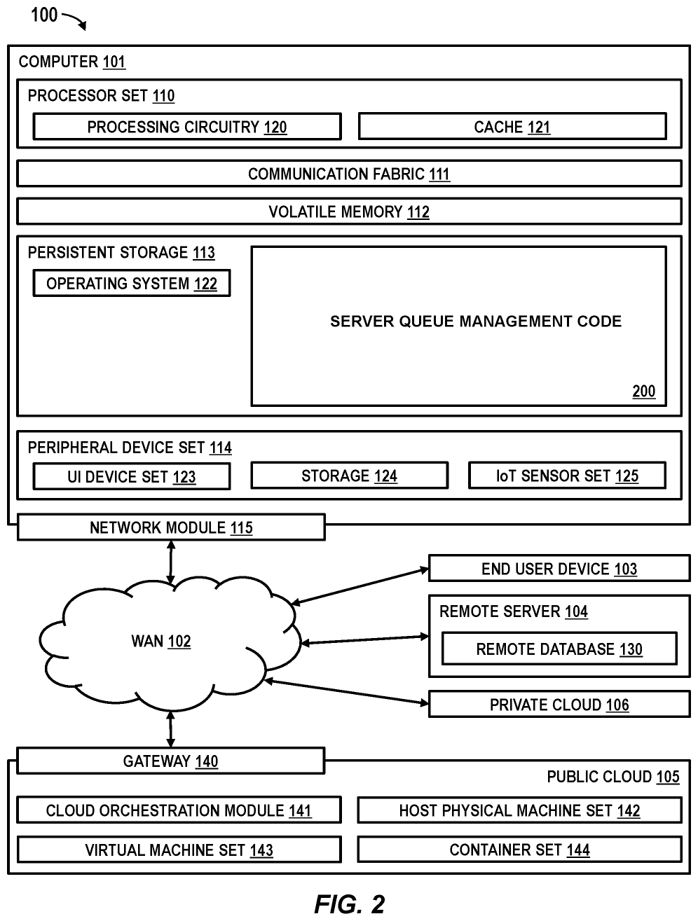

Referring now to FIG. 2, an illustrative computing environment 100 is depicted. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a proposed method for managing requests for a server queue for a system (i.e., server queue management code) 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

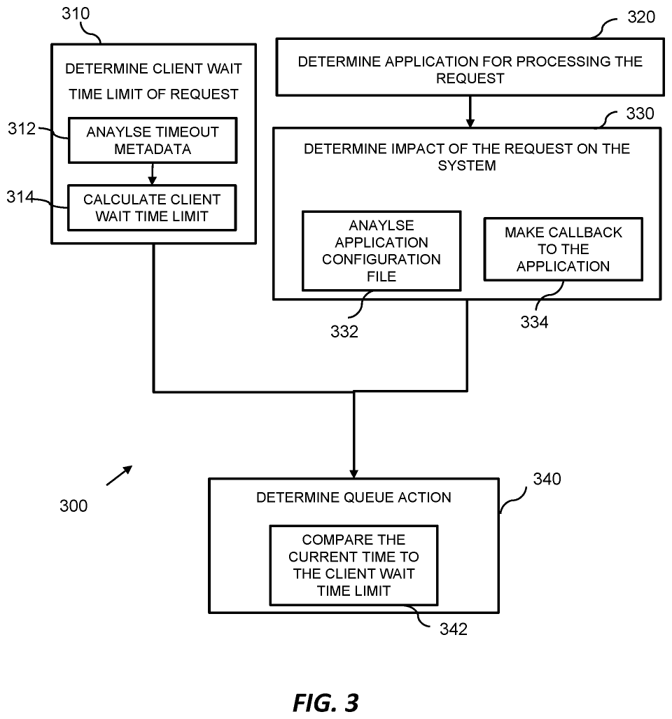

Referring now to FIG. 3, there is depicted a flow diagram of a computer-implemented method 300 for managing a request in a server queue for a system according to a purely exemplary embodiment.

The method 300 begins with the step 310. Step 310 comprises analysing a request to be added to the server queue to determine a client wait time limit. In this example, the request is received at the server from a client, and the client wait time limit describes an absolute time at which the client will stop waiting for the impact of processing the request. Step 310 comprises the two sub-steps 312 and 314.

Step 312—analyse timeout metadata associated with the request. For example, the timeout metadata may comprise at least one of an absolute time or a duration. In detail, the timeout metadata may provide a request specific measure of the time period for which the client will remain waiting for a response to the request. This information may be stored for example, in a header of the request.

Step 314—calculate, based on the timeout metadata, the client wait time limit being the absolute time at which the client will stop waiting for a response to the request.

Step 320 comprises determining an application for processing the request. The method then proceeds to step 330 wherein the application is analysed to determine an impact of processing the request on a system state. In this example, the impact of processing the request on the system state may be at least one of; modifying data; adding data; removing data; and reading data.

In this exemplary embodiment, information describing the impact of processing the request is stored in the application and may be determined by the sub-steps 332 and 334: Step 332—analyse an application configuration file to determine the impact of processing the request; and Step 334—make a callback to the application to determine the impact of processing the request.

It is understood, that after the completion of steps 310, 320 and 330, the server has determined the client wait time limit and the impact of the request. Further, it is understood that determining these two pieces of information may occur in any sequential order, or concurrently, or in processes in some part overlapping in time.

After completion of steps 310, 320 and 330, the method moves onto step 340 of determining a queue action for the request based on the client wait time limit and the impact of the request. In this example, the queue action for the request may be at least one of; removing the request from the queue; changing the position of the request in the queue; and maintaining the position of the request in the queue.

In this exemplary method the step 340 comprises the sub-step 342 comprising comparing the client wait time limit to the current time to determine the queue action.

Although the client wait time limit determined in step 310 of FIG. 3, has been detailed as defining an absolute time at which the client will stop waiting for a request, in alternative embodiments there may be described a different form of the client wait time limit. For example, the client wait time limit may be a duration after the request is added to queue for which the client remains waiting for a response. Additionally, the step 342 comparing the client wait time limit to the current time to determine the queue action, may in alternative embodiments involve analysing the duration of time the request has been in the queue.

Similarly, other steps of the method detailed above may be implemented differently in alternative embodiments. For instance, the step 312 may not involve analysing timeout metadata, the client timeout limit could be determined instead by analysing the connection state of the client. In this exemplary embodiment, the determined queue action describes an action to be taken whilst the request remains in the queue. However, in an alternative embodiment the queue action may relate to an action to be taken upon the request leaving the queue. For example, the queue action may be to discard the request once it has left the queue, or to process the request once it has left the queue.

From the above description, it will be appreciated that the exemplary method of FIG. 3 may be employed to determine a queue action for a request in a server queue. Also, the method may be used repeatedly on a plurality of requests in a queue. In this way, embodiments may ensure management of the entirety of a server queue to ensure efficient use of server resources during busy periods.

Thus, there are proposed one or more concepts for automatically managing requests in a server queue using information describing the impact of the request on the system, and the time at which the client associated with the request will stop waiting for a response. Thus, the proposed method allows for safe management of requests in a server that is operating at maximum processing capacity, to help ensure that the server is not wasting resources processing low impact requests for which the client has stopped waiting for a response.

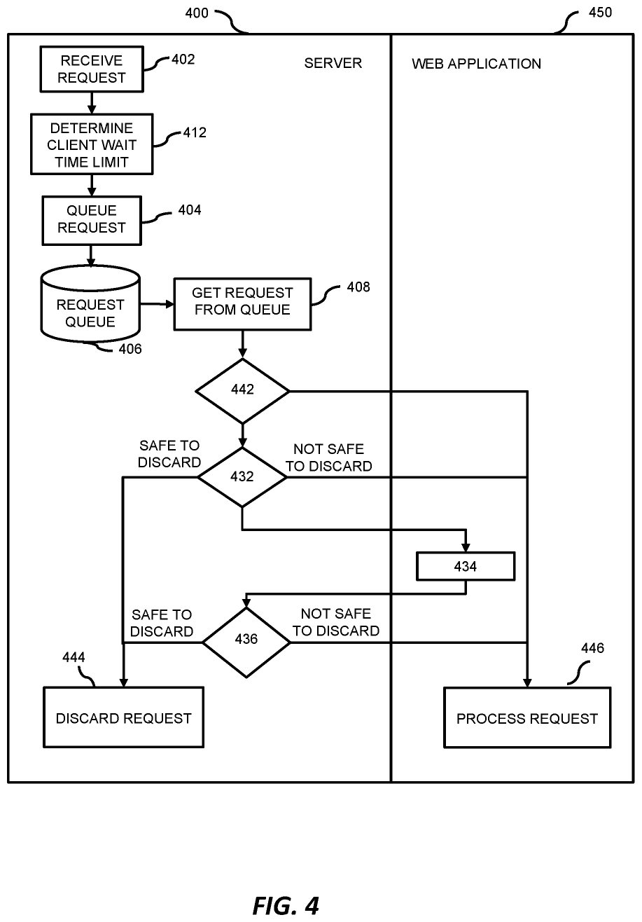

Purely by way of further description, an implementation of an embodiment will now be described with reference to FIG. 4. FIG. 4 depicts a simplified flow diagram showing the interaction between a server 400 and a web application 450 for the management of a queue of server requests according to the present disclosure.

In this example embodiment, the server 400 receives a request from a client in step 402. In a step 412, the server determines a client wait time limit from the received request, wherein the client wait time limit describes an absolute time at which the client will stop waiting for a response to the request. In a step 404, the request is placed in the server request queue 406.

The method then proceeds to a step 408. Step 408 comprises the server getting the next request from the queue. The decision step 442 comprises comparing the current time to the client wait time limit associated with the request. If the current time is before the client wait time limit, the server proceeds to process the request in the web application 450 (step 446). If the current time is after the client wait time limit, the client has stopped waiting for a response to the request and the server proceeds to step 432.

Step 432 comprises analysing the application configuration file in the server to determine an indicator of the intent of the request. If, as a result of this analysis, it is determined the request is safe to discard, the request is discarded in a step 444; if it is determined that it is not safe to discard the request the request is processed in a step 446. If the server is unable to determine whether the request is safe to discard from the application configuration file, the method proceeds to step 434.

Step 434 comprises making a callback to the application to determine an indicator of the intent of the request. This callback response is analysed in the server in step 436 to determine if the request is safe to discard. If, as a result of this analysis, it is determined the request is safe to discard, the request is discarded in step 444; if it is determined that it is not safe to discard the request, the request is processed in the application in step 446.

From the above description, it will be understood that there are proposed concepts for managing requests in a server queue. These concepts may facilitate the management of requests in a manner that is superior to existing approaches, as they allow requests to be managed based on both a request specific client wait time limit and information on the influence of the request from the application. For instance, proposed embodiments may allow low impact requests to be safely discarded by the server during busy periods if the client has stopped waiting for a response to the request.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

It should now be understood by those of skill in the art, in embodiments of the present invention, the proposed concepts provide numerous advantages over conventional queue management methods. These advantages include, the more efficient use of server resources by determining a suitable queue action for a request in a queue.

In still further advantages to a technical problem, the systems and processes described herein provide a computer-implemented method for efficient schema generation. In this case, a computer infrastructure, such as the computer system shown in FIGS. 1 and 2 can be provided and one or more systems for performing the processes of the invention can be obtained (e.g., created, purchased, used, modified, etc.) and deployed to the computer infrastructure. To this extent, the deployment of a system can comprise one or more of:
(i) installing program code on a computing device, such as computer system shown in FIG. 2, from a computer-readable medium;
(ii) adding one or more computing devices to the computer infrastructure and more specifically the cloud environment; and
(iii) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for managing requests in a server queue, the method comprising:
analysing a request to be added to the server queue to determine a client wait time limit;
determining an application for processing the request;
analysing the application to determine an indicator of intent of the request; and
determining a queue action for the request based on the client wait time limit and the indicator of intent of the request.

2. The method of claim 1, wherein analysing a request to determine a client wait time limit comprises:
analysing timeout metadata associated with the request; and
calculating, based on the timeout metadata, the client wait time limit.

3. The method of claim 1, wherein the request is received at the server from a client, and wherein the client wait time limit describes an absolute time at which the client will stop waiting for the request.

4. The method of claim 1, wherein determining the queue action involves comparing the client wait time limit to a current time.

5. The method of claim 1, wherein analysing the application comprises analysing an application configuration file.

6. The method of claim 1, wherein the indicator of intent of the request indicates whether the request is safe to discard.

7. The method of claim 1, wherein the queue action for the request comprises changing a position of the request in the queue.

8. The method of claim 1, wherein determining the queue action for the request comprises:
determining the queue action is to maintain the position of the request in the queue in response to determining that the client wait time limit equals a first predetermined value.

9. The method of claim 1, wherein determining the queue action for the request comprises:
determining the queue action is to maintain the position of the request in the queue in response to determining that an impact of the request equals a second predetermined value.

10. The method of claim 1, wherein determining the queue action for the request comprises:
determining the queue action is to remove the request from the queue in response to determining that the client wait time has a third predetermined value and an impact of the request has a fourth predetermined value.

11. A computer program product comprising one or more computer readable storage media, and program instructions collectively stored on the one or more computer readable storage media, the program instructions comprising instructions configured to cause one or more processors to perform a method for managing requests in a server queue comprising:
analysing a request to be added to the server queue to determine a client wait time limit;
determining an application for processing the request;
analysing the application to determine an indicator of intent of the request; and
determining a queue action for the request based on the client wait time limit and the indicator of intent of the request.

12. A system comprising:
one or more processors; and
one or more computer-readable storage media collectively storing program instructions which, when executed by the one or more processors, are configured to cause the one or more processors to perform a method for managing requests in a server queue comprising:
analysing a request to be added to the server queue to determine a client wait time limit;
determining an application for processing the request;
analysing the application to determine an indicator of intent of the request; and
determining a queue action for the request based on the client wait time limit and the indicator of intent of the request.

13. The system of claim 12, wherein analysing a request to determine a client wait time limit comprises:
analysing timeout metadata associated with the request; and
calculating, based on the timeout metadata, the client wait time limit.

14. The system of claim 13, wherein the timeout metadata of the request comprises a duration of time the request has been in the server queue.

15. The system of claim 12, wherein determining the queue action includes comparing the client wait time limit to a current time.

16. The system of claim 12, wherein analysing the application includes making a callback to the application.

17. The system of claim 12, wherein the indicator of intent of the request indicates whether the request is safe to discard.

18. The system of claim 12, wherein the queue action for the request comprises removing the request from the server queue.

19. The system of claim 12, wherein determining the queue action for the request comprises:
determining the queue action is to maintain the position of the request in the server queue in response to determining that the client wait time limit equals a first predetermined value.

20. The system of claim 12, wherein determining the queue action for the request comprises:
determining the queue action is to maintain the position of the request in the server queue in response to determining that an impact of the request equals a second predetermined value.
